(19) United States
(12) Patent Application Publication
(10) Pub. No.: US 2019/0379223 A1
(43) Pub. Date: Dec. 12, 2019

(54) SYSTEM FOR CHARGING BATTERIES USED IN CLOTHING

(71) Applicant: CYBERX Engineering Inc., Wilmington, DE (US)

(72) Inventors: Kirill Khaliuta, Saint Petersburg (RU); Sergei Belov, Saint Petersburg (RU); Artur Temirbekov, Saint Petersburg (RU)

(21) Appl. No.: 16/044,709

(22) Filed: Jul. 25, 2018

Related U.S. Application Data
(63) Continuation-in-part of application No. 16/003,211, filed on Jun. 8, 2018, now Pat. No. 10,201,195.

(51) Int. Cl. H02J 7/00; A47G 25/32

(52) U.S. Cl. CPC H02J 7/0045; H02J 7/0029; H02J 7/0052; H02J 2007/0049; A47G 25/32; H02J 2007/0062; H02J 7/0047

(57) ABSTRACT

A system for charging batteries of clothing is provided. The system may include a body made of an electric insulation material. The body can be configured to receive a hanging loop of the clothing. The system may include first electrical contacts disposed on the body, and a wire at least partially disposed within the body. The wire may be configured to provide an electric current to the first electrical contacts. The system may include second electrical contacts disposed in the hanging loop of the clothing. The second electrical contacts may be configured to electrically connect to the battery of the clothing. The first electrical contacts may be configured to touch the second electrical contacts when the hanging loop is hung on the body.

### CROSS-REFERENCE TO RELATED APPLICATIONS

The present application is a Continuation-In-Part of U.S. patent application Ser. No. 16/003,211 titled “Heating System for Clothing,” filed Jun. 8, 2018. The subject matter of the aforementioned application is incorporated herein by reference for all purposes.

### TECHNICAL FIELD

This disclosure generally relates to clothing. More specifically, this disclosure relates to systems for charging batteries used in clothing.

### BACKGROUND

Modern clothing may include electrically-powered components to provide additional functionality to users. For example, clothing may include heating components, indicator lights, touchscreens, sensors, accelerometers, gyroscopes, Global Positioning System (GPS) trackers, and so forth. One disadvantage of existing clothing is that they use an external battery or removable battery for providing electricity to the electrically-powered components. To be recharged, the removable battery needs to be unplugged from the clothing and plugged into a charging device.

### SUMMARY

This section introduces a selection of concepts in a simplified form that are further described in the Detailed Description section, below. This summary does not identify key or essential features of the claimed subject matter and is not intended to be an aid in determining the scope of the claimed subject matter.

This disclosure is generally concerned with systems and methods for charging batteries of clothing. The present technology may provide an improvement for recharging batteries of the clothing without the need for unplugging and removing the batteries from the clothing. The present technology may also provide a convenient way for recharging a battery installed in the clothing by hanging the clothing on a hanging hook or a hanger. Below are some embodiments of the present disclosure, while other embodiments should be evident from the following detailed description of example embodiments, claims, and accompanying drawings.

According to one embodiment of this disclosure, there is provided a system for charging a battery of a clothing. The system may include a body made of an electric insulation material, first electrical contacts disposed on the body, and a wire at least partially disposed within the body. The first electrical contacts may be configured to receive second electrical contacts. The second electrical contacts may be disposed on the clothing. The second electrical contacts may be configured to be electrically connected to the battery of the clothing. The wire may be configured to provide electric current to the first electrical contacts.

According to another embodiment of this disclosure, a method for charging a battery of a clothing is provided. The method may commence with disposing first electrical contacts on a platform of a hanging hook. The hanging hook may be made of an electric insulation material. The method may further include disposing a wire at least partially within the hanging hook. The wire may be configured to provide an electric current to the first electrical contacts from a power source. The method may further include disposing second electrical contacts in a hanging loop of the clothing. The second electrical contacts may be electrically connected with the battery of the clothing. The second electrical contacts may be configured to touch the first electrical contacts when the hanging loop is disposed on the platform of the hanging hook.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities, and combinations particularly pointed out in the appended claims.

### BRIEF DESCRIPTION OF THE DRAWINGS

Embodiments are illustrated by way of example and not limitation in the figures of the accompanying drawings, in which like references indicate similar elements and in which:

FIG. 1 is a block diagram of an electrical system of clothing, according to an example embodiment of the present disclosure.

FIG. 2 is a block diagram of a system for charging a battery of clothing, according to an example embodiment of the present disclosure.

FIG. 3 shows a jacket and a hanging loop, according to an example embodiment of the present disclosure.

FIG. 4 shows a hanging loop of clothing, according to an example embodiment of the present disclosure.

FIG. 5A is a front view of a hanging loop of a jacket, according to an example embodiment of the present disclosure.

FIG. 5B is a back view of a hanging loop of a jacket showing inner elements of the hanging loop, according to an example embodiment of the present disclosure.

FIG. 6 is a right-angle view of a hanging hook for charging a battery of clothing, according to an example embodiment of the present disclosure.

FIG. 7A is a front view the hanging hook of FIG. 6.

FIG. 7B is a right-side view of the hanging hook of FIG. 6.

FIG. 7C is a right-side angle view of the hanging hook of FIG. 6.

FIG. 8 shows an example environment within which a system and a method for charging a battery of a clothing can be implemented.

FIG. 9 is a flow chart showing a method for charging a battery of a clothing, according to an example embodiment.

### DETAILED DESCRIPTION OF EXAMPLE EMBODIMENTS

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Embodiments of this disclosure are concerned with charging systems for charging batteries of clothing. The methods and systems of this disclosure may allow charging a battery of clothing containing electrically-powered components without the need for unplugging and removing the battery from the clothing.

According to an example embodiment, a system for charging a battery of a clothing may include a body made of an electric insulation material, first electrical contacts disposed on the body, and a wire. The first electrical contacts may be configured to receive second electrical contacts. The second electrical contacts may be disposed in a hanging loop of the clothing and may be configured to be electrically connected to a battery disposed within the clothing. The wire may be at least partially disposed within the body to provide an electric current to the first electrical contacts. The wire may be connected to a power source. The power source may include a wall electrical outlet, an external accumulator, a power bank, and any other power source. Therefore, when the first electrical contacts are in contact with the second electrical contacts, the electric current may pass from the power source to the first electrical contacts, from the first electrical contacts to the second electrical contacts, and from the second electrical contacts to the battery of the clothing.

In one example embodiment, the body of a system for charging a battery of clothing may be in a form of a hanging hook. In this case, the second electrical contacts of the clothing may be placed within a hanging loop of the clothing. The body in a form of the hook may include a platform for receiving the hanging loop. The first electrical contacts may be disposed on the platform. The clothing may be hung on the body by placing the hanging loop on the platform of the body. Upon placing the hanging loop on the platform of the body, the first electrical contacts may touch the second electrical contacts. Therefore, the battery of the clothing may be charged by hanging the clothing using the hanging loop onto the body of the system for charging the battery of the clothing. The hanging hook may be attached to the wall or hung on the closet rod, for example, in a cloakroom, wardrobe, hall, and the like.

In another example embodiment, the body may be configured in a form of a hanger. The first electrical contacts may be disposed on a top side of the hanger. In this case, the second electrical contacts of the clothing may be disposed within an inner side of the clothing, for example, in an area of shoulders or any other area, to engage the first electrical contacts when the clothing is hung on the hanger.

Referring now to the drawings, exemplary embodiments are described. The drawings are schematic illustrations of idealized example embodiments. Thus, the example embodiments discussed herein should not be construed as limited to the particular illustrations presented herein, rather these example embodiments can include deviations and differ from the illustrations presented herein.

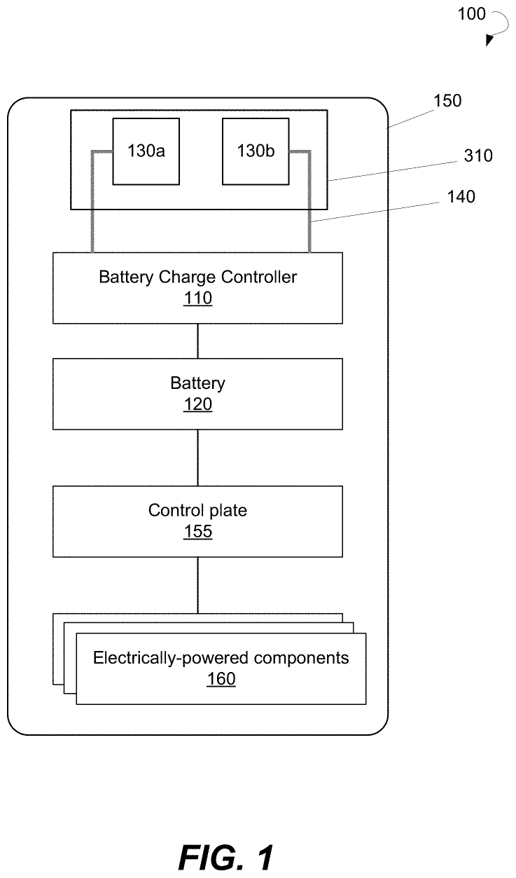

FIG. 1 is a block diagram of an electrical system 100 of a clothing, according to some example embodiment of the present disclosure. The electrical system 100 may have a plurality of elements disposed inside the clothing 150. Specifically, the electrical system 100 may have electrical contacts 130a and 130b disposed in the clothing 150. The electrical contacts 130a and 130b may be connected to a battery charge controller 110. In some embodiments, the electrical contacts 130a and 130b can be placed on a hanging loop 310 of the clothing 150. The connections between the electrical contacts 130a and 130b and the battery charge controller 110 may be performed using a wire 140. The battery charge controller 110 can be connected to a battery 120 of the clothing 150. The electrical system may further include a control plate 155 and a plurality of the electrically-powered components 160.

The electrically-powered components 160 may be disposed within the clothing 150. Each of the electrically-powered components 160 may be powered by the battery 120. The control plate 155 can be configured to control amount of electrical current delivered from the battery 120 to the electrically-powered components. The electrically-powered component may include heating elements, touch screen devices, indicator lights, GPS trackers, accelerometers, gyroscopes, temperature sensors, pressure sensors, and other components which may depend on functionalities of the clothing 150.

In an example embodiment, the battery 120 may include a flexible battery. The battery 120 may include a plurality of silver-zinc cells. The battery 120 may include five silver-zinc cells. Each cell of battery 120 may have an operating voltage of 1.55 Volts and a charging voltage of 2.05 Volts. An overall battery operating voltage may not exceed 7.55 Volts and an overall battery charging voltage may not exceed 10.25 Volts.

The battery charge controller 110 may include, for example, controller BQ24773 of Texas Instruments. Charging of the battery 120 can be performed in a way that ensures an optimal condition for silver-zinc cells. The cells of the battery 120 can be charged in parallel. The charging process can include a first mode for the beginning of the charging process and a second mode for the end of the charging process. The first mode can be associated with a constant current and the second mode can be associated with a constant voltage. The voltage of the second mode can be rigidly limited to 2.05 Volts for each cell of the battery.

The battery charge controller 110 may include a system power monitor and a processor hot indicator. The battery charge controller 110 may be configured to stop charging or discharging the battery 120 when a temperature of any cell of the battery 120 exceeds a pre-determined value.

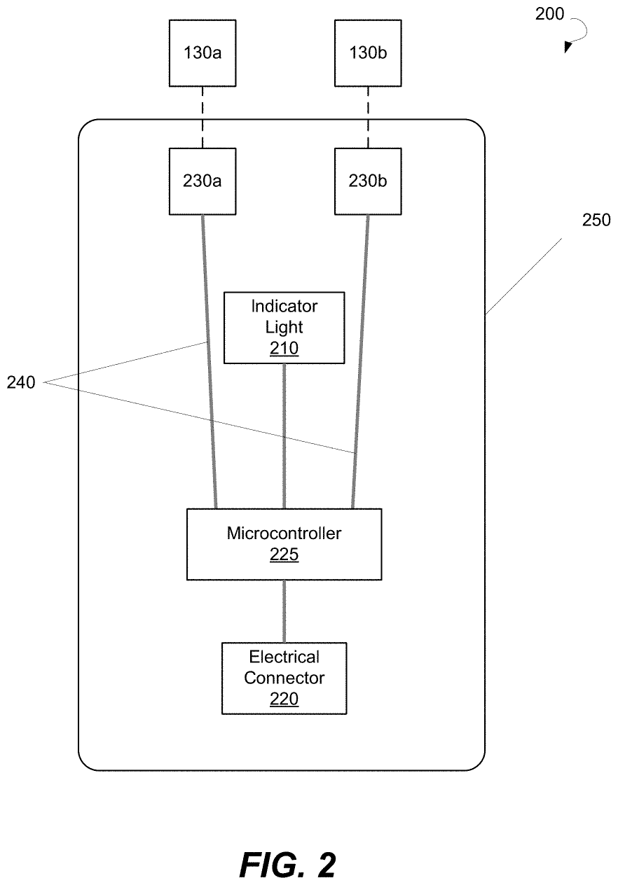

FIG. 2 is a block diagram of a system 200 for charging a battery of a clothing, according to an example embodiment. The system 200 may include a body 250, electrical contacts 230a and 230b disposed on the body 250, a microcontroller 225, and a wire 240 at least partially disposed within the body 250. The body 250 may be made of an electric insulation material. The electrical contacts 230a and 230b may be configured to receive the electrical contacts 130a and 130b disposed in the clothing 150. The electrical contacts 130a and 130b may be electrically connected to the battery charge controller 110 of the clothing 150. When the electrical contacts 130a and 130b touch the electrical contacts 230a and 230b, the battery charge controller 110 may charge the battery 120 of the clothing.

In some embodiments, the electrical contacts 130a and 130b may be placed within a hanging loop of the clothing. The body 250 of the system 200 may include a platform for receiving the hanging loop. The electrical contacts 230a and 230b may be disposed on the platform and may touch the electrical contacts 130a and 130b of the hanging loop when the hanging loop is disposed on the platform.

In some embodiments, the wire 240 may be directly connectable to a power source (not shown). In other embodiments, the system 200 may further include an electrical connector 220 that may be disposed within the body 250 and electrically connected to the wire 240. The electrical connector 220 may be configured to be connectable to an external cable (not shown) to receive the electric current from the power source. The electrical connector 220 may include a Universal Serial Bus (USB) connector, an USB type C connector, and the like. Correspondently, the external cable may include an USB cable, an USB Type C cable, and the like. In one embodiment, the body 250 may be in a form of a hanger. The electrical contacts 230a and 230b may be disposed on a top side of the hanger. The electrical contacts 130a and 130b of the clothing may be disposed within an inner side of the clothing so as to engage, that is to electrically contact, the electrical contacts 230a and 230b when the clothing is hung on the hanger.

In some embodiments, the microcontroller 225 can be configured to control electrical current flowing from the wire 240 to the electrical contacts 230a and 230b. The microcontroller 240 may include a voltage and current converter to transform electrical current received from a wire to an electrical current of a pre-determined voltage and amperage. The microcontroller 240 may include a protective circuit breaker configured to disconnect the wire 240 and the electrical contacts 230a and 230b if the electrical contacts 230a and 230b become short circuited.

The system 200 may further include a light indicator 210 disposed on the body 250. The light indicator 210 may be electrically connected in parallel to the electrical contacts 230a and 230b. The light indicator 210 may be configured to emit a first color light when the battery is charging and a second color light when the battery finished charging. Specifically, when the electric current runs from the electrical contacts 230a and 230b to the electrical contacts 130a and 130b during charge of the battery 120, the light indicator 210 may emit the first color light. When the electrical contacts 230a and 230b are in contact with the electrical contacts 130a and 130b, but the battery 120 does not consume the electric current from the electrical contacts 130a and 130b, the battery may be fully charged. In this case, the light indicator 210 may emit the second color light. The light indicator 210 may include a light-emitting diode indicator.

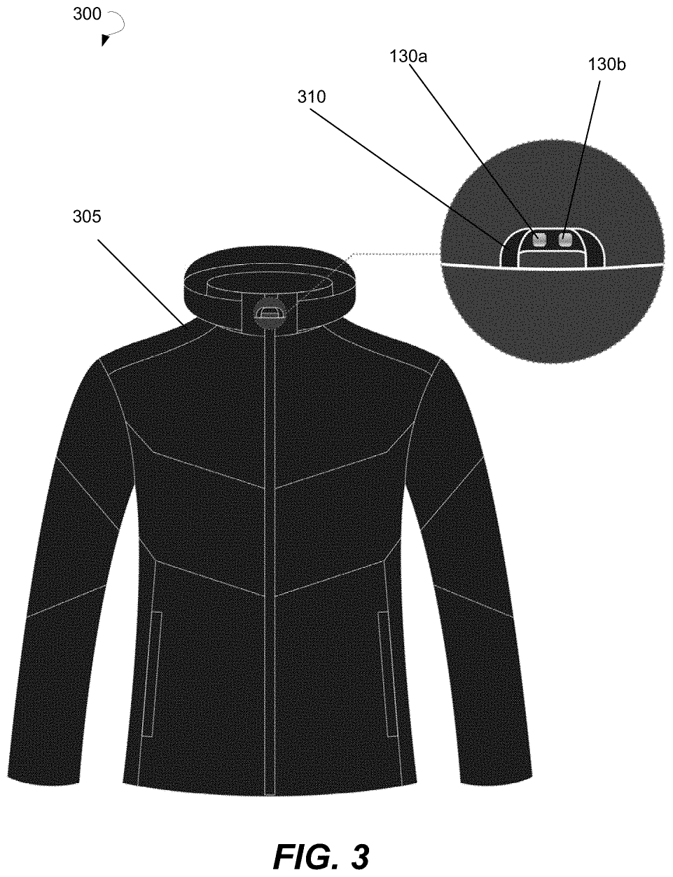

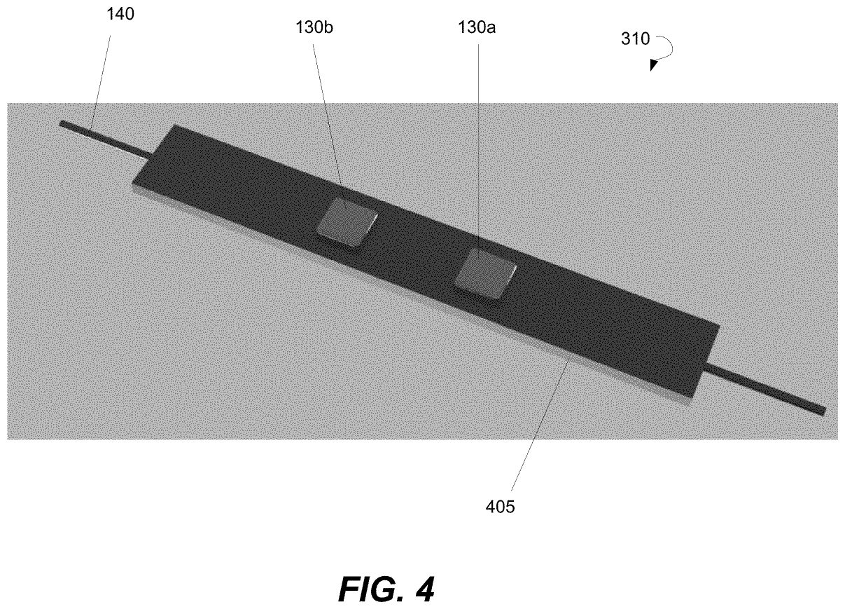

FIG. 3 shows a jacket 305, according to an example embodiment. The jacket may include an electrical system 100. The jacket 305 may include a hanging loop 310. The hanging loop 310 may include electrical contacts 130a and 130b. The hanging loop 310 is shown in detail on FIG. 4.

FIG. 4 depicts a hanging loop 310 of clothing, according to an example embodiment. The hanging loop 310 may include a base 405 and electrical contacts 130a and 130b disposed in the base 405. The base 405 may be made of a flexible material allowing bending of the hanging loop 310. The hanging loop 310 may further include a wire 140 for connecting the electrical contacts 130a and 130b to the battery charge controller 110.

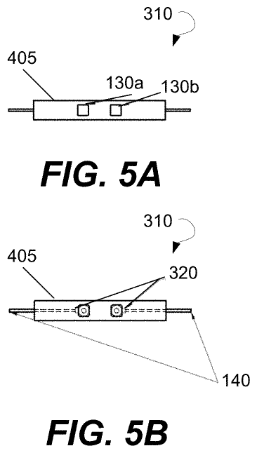

FIG. 5A is a front view of a hanging loop 310 of clothing, according to an example embodiment. FIG. 5B is a back view of a hanging loop 310 of clothing, according to an example embodiment. FIG. 5B is showing inner elements of the hanging loop. Specifically, FIG. 5A shows electrical contacts 130a and 130b disposed in a base 405 of the hanging loop 310. FIG. 5B shows electrical contacts 130a and 130b connected to a wire 140 using washers 320. The washers 320 may be located inside the base 405 of the hanging loop 310 and may secure the electrical contacts 130a and 130b to the wire 140 and the base 405.

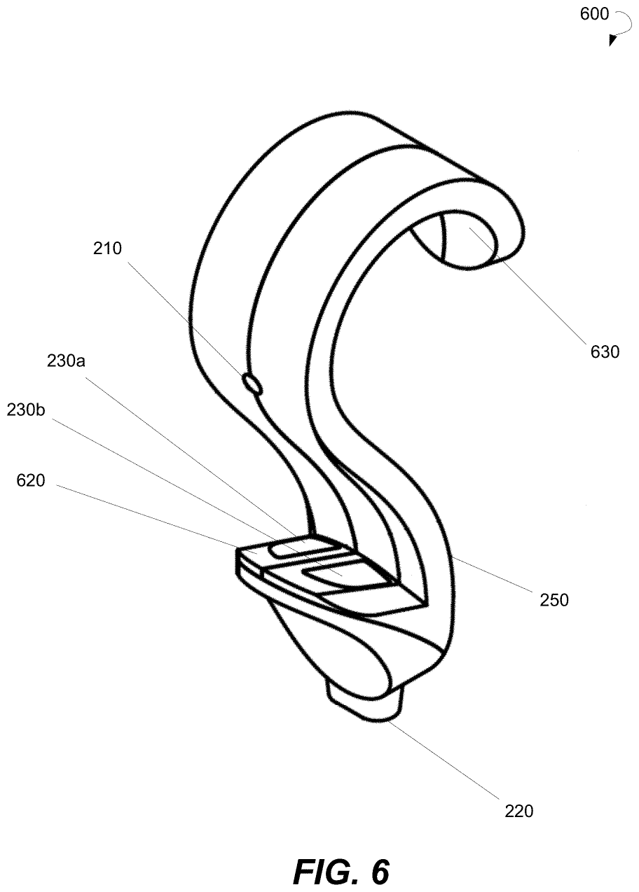

FIG. 6 is a right-angle view of a hanging hook 600 for charging a battery of clothing, according to an example embodiment. The hanging hook 600 may include a body 250, electrical contacts 230a and 230b disposed on the body 250, and a platform 620 for receiving a hanging loop of the clothing. The body 250 may have an upper part shaped in a form of a hook 630. The hook 630 may be configured to be hung, for example, on a closet rod. The electrical contacts 230a and 230b may be disposed on the platform 620 and may touch the electrical contacts 130a and 130b of the hanging loop 310 when the hanging loop 310 is disposed on the platform 620.

The hanging hook 600 may further include an electrical connector 220 disposed within the body 250 and electrically connected to a wire (not shown). The electrical connector 220 may be configured to connect to an external cable (not shown) to receive the electric current from a power source.

The hanging hook 600 may further include a light indicator 210 coupled to the body 250. The light indicator 210 may be electrically connected in parallel to the first electrical contacts 230a and 230b. The light indicator 210 may operate in several modes. Specifically, the light indicator 210 may emit a first color light when the battery of the clothing is charging and emit a second color light when the battery has finished charging and is currently completely charged. In an example embodiment, the light indicator 210 may be a light-emitting diode indicator.

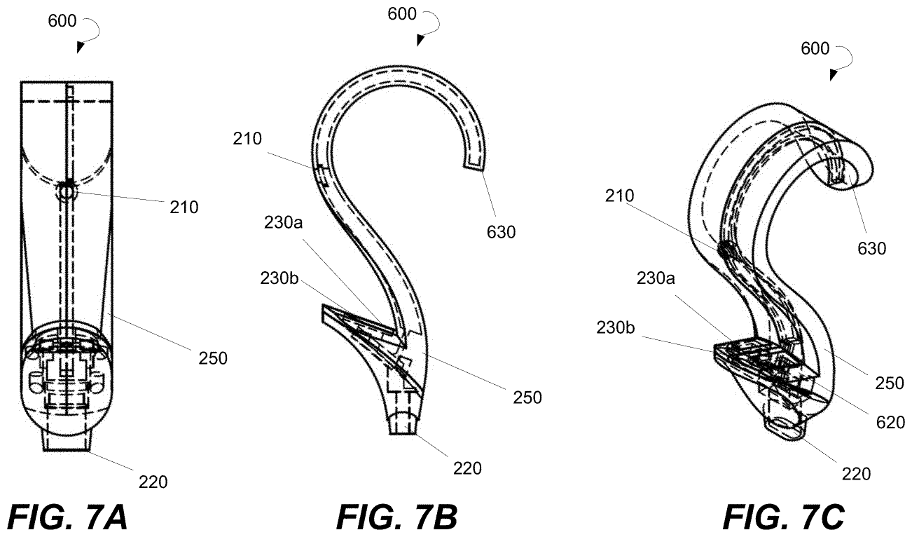

FIG. 7A is a front view of the hanging hook 600. FIG. 7B is a right-side view of the hanging hook 600. FIG. 7C is a right-side angle view of the hanging hook 600. In FIGS. 7A-7C, body 250 includes a light indicator 210, electrical contacts 230a and 230b disposed on platform 620, and an electrical connector 220. The body 250 also includes a hook 630.

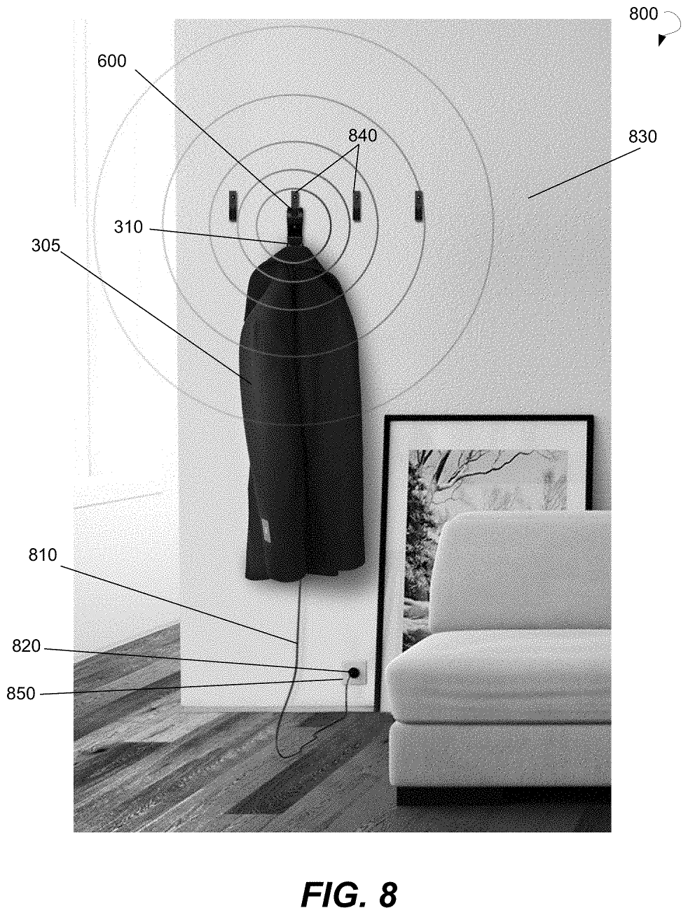

FIG. 8 shows an example environment 800 within which a system and a method for charging a battery of clothing can be implemented. The example environment 800 may include a hanging hook 600 for charging a battery of a clothing, the jacket 305, a hanging loop 310 disposed in the jacket 305, a wall 830, an external cable 810, an electrical plug 820, and a wall electrical outlet 850. The environment 800 may further include one or more hooks 840 rigidly attached to the wall 830. The hanging hook 600 may be hung on one of the hooks 840.

The external cable 810 may be connected to the electrical plug 820. The external cable 810 may be a USB cable, a USB type C cable, or any other type of cable and may be configured to be attached, by one its end, to an electrical connector of the hanging hook 600. The electrical plug 820 may include a voltage and current converter to transform electrical current from the wall electrical outlet 850 to a low voltage electrical current.

The hanging loop 310 of the jacket 305 may be placed on a platform of a body of the hanging hook 600. When the hanging loop 310 is placed on the hanging hook 600, electrical contacts of the hanging hook 600 receive electrical contacts of the hanging loop 310. The external cable 810 is connected to the hanging hook 600 and passes the electric current from an electric grid to the electrical contacts of the hanging hook 600. In turn, the electrical contacts of the hanging hook 600 pass the electric current to the electrical contacts of the hanging loop 310. The electrical contacts of the hanging loop 310 are electrically connected to the battery of an electrical system disposed within the jacket 305 and charge the battery by passing the electric current to the battery.

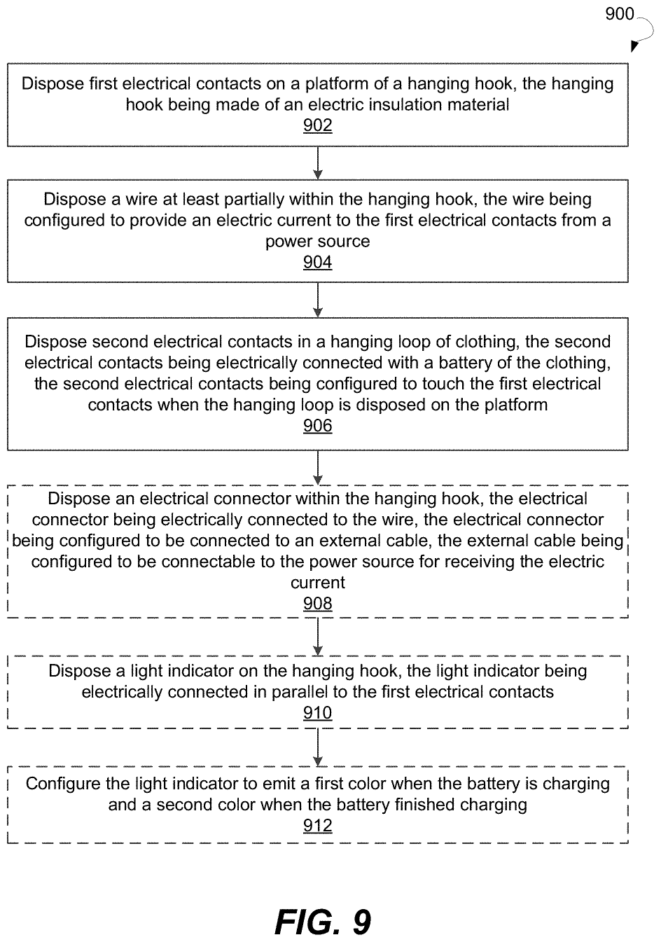

FIG. 9 is a flow chart 900 showing a method for charging a battery of a clothing, according to an example embodiment. The method 900 may commence with disposing first electrical contacts on a platform of a hanging hook at operation 902. The hanging hook may be made of an electric insulation material. The method 900 may continue with disposing a wire at least partially within the hanging hook at operation 904. The wire may be configured to provide an electrical current to the first electrical contacts from a power source. In an example embodiment, the wire may be configured to be directly connectable to the power source. The method 900 may further include disposing second electrical contacts disposed in a hanging loop of the clothing at operation 906. The second electrical contacts may be electrically connected to the battery disposed in the clothing. The second electrical contacts may be configured to touch the first electrical contacts when the hanging loop is disposed on the platform.

The method 900 may further include disposing an electrical connector within the hanging hook at optional operation 908. The electrical connector may be electrically connected to the wire and may be configured to be connected to an external cable. The external cable may be connectable to the power source for receiving the electric current. The electrical connector may include a USB, USB type C connector, and the like. The external cable may include a USB cable, USB type C cable, and the like.

The method 900 may further include disposing a light indicator on the hanging hook at optional operation 910. The light indicator may be electrically connected in parallel to the first electrical contacts. The method 900 may further include optional operation 912 at which the light indicator may be configured to emit a first color light when the battery is charging and emit a second color light when the battery finished charging. The light indicator may include a light-emitting diode indicator.

Thus, systems and methods for charging batteries of clothing have been described. Although embodiments have been described with reference to specific example embodiments, it will be evident that various modifications and changes can be made to these example embodiments without departing from the broader spirit and scope of the present document. Accordingly, the specification and drawings are to be regarded in an illustrative rather than a restrictive sense.

1. A system for charging a battery of a clothing, the system comprising:
a hanging loop attached to the clothing, wherein the hanging loop includes first electrical contacts disposed on a surface of the hanging loop, the first electrical contacts being electrically connected to the battery of the clothing;
a body made of an electric insulation material, the body being configured to receive the hanging loop of the clothing, wherein the body includes:
second electrical contacts disposed on the body, the second electrical contacts being configured to receive first electrical contacts when the clothing is hung by the hanging loop on the body; and
a wire at least partially disposed within the body and configured to provide an electric current to the second electrical contacts.

2. The system of claim 1, wherein the first electrical contacts are configured to be electrically connected to a battery charge controller of a battery rigidly mounted within the clothing.

3. The system of claim 1, further comprising a microcontroller disposed within the body and configured to control the electrical current from the wire to the second electrical contacts.

4. The system of claim 3, wherein the microcontroller is configured to prevent short circuits in the second electrical contacts.

5. The system of claim 1, further comprising an electrical connector disposed within the body and electrically connected to the wire, the electrical connector being configured to connect to an external cable to receive the electric current from a power source.

6. The system of claim 5, wherein:
the electrical connector includes a Universal Serial Bus (USB) type C connector; and
the external cable includes a USB Type C cable.

7. The system of claim 1, wherein the body includes a platform for receiving the hanging loop.

8. The system of claim 1, wherein the body is configured to be rigidly attached to a wall.

9. The system of claim 1, wherein the body includes a hook for hanging the body on a further hook attached to a wall.

10. The system of claim 1, wherein the body includes a hook for hanging the body on a closet rod.

11. The system of claim 1, further comprising a light indicator coupled to the body, the light indicator being electrically connected in parallel to the second electrical contacts and configured to emit:
a first color light when the battery is charging; and
a second color light when the battery is finished charging.

12. The system of claim 11, wherein the light indicator includes a light-emitting diode indicator.

13. A method for charging a battery of a clothing, the method comprising:
providing a hanging loop attached to the clothing;
disposing first electrical contacts on a surface of the hanging loop, the first electrical contacts being electrically connected to the battery of the clothing;
providing a hanging hook made of an electric insulation material, the hanging hook being configured to receive the hanging loop of the clothing;
disposing second electrical contacts on the hanging hook, the second electrical contacts being configured to receive the first electrical contacts when the clothing is hung by the hanging loop on the hanging hook; and
disposing a wire at least partially within the hanging hook, the wire being configured to provide an electric current to the second electrical contacts from a power source.

14. The method of claim 13, further comprising disposing a microcontroller within the hanging hook, the microcontroller being configured to control the electrical current from the wire to the second electrical contacts.

15. The method of claim 13, further comprising disposing an electrical connector within the hanging hook, the electrical connector being electrically connected to the wire, the electrical connector being configured to be connected to an external cable, the external cable being configured to be connectable to the power source for receiving the electric current.

16. The method of claim 15, wherein:
the electrical connector includes a Universal Serial Bus (USB) type C connector; and
the external cable includes a USB Type C cable.

17. The method of claim 13, wherein the hanging hook is configured to be hung on a closet rod or a further hook attached to the wall.

18. The method of claim 13, further comprising:
disposing a light indicator on the hanging hook, the light indicator being electrically connected in parallel to the second electrical contacts; and
configuring the light indicator to emit:
a first color light when the battery is charging; and
a second color light when the battery finished charging.

19. The method of claim 18, wherein the light indicator includes a light-emitting diode indicator.

20. A system for charging a battery of a clothing, the system comprising:
a hanging loop attached to the clothing, wherein the hanging loop includes first electrical contacts disposed on a surface of the hanging loop, the first electrical contacts being electrically connected to the battery of the clothing;
a body made of an electric insulation material, wherein the body includes:
a platform for receiving the hanging loop of the clothing and a hook for hanging the body on a closet rod or a further hook attached to a wall;
second electrical contacts disposed on the platform of the body,
the second electrical contacts being configured to receive the first electrical contacts when the clothing is hung by the hanging loop on the platform;
a wire disposed within the body and configured to provide an electric current to the second electrical contacts;
a microcontroller disposed within the body, the microcontroller being configured to control the electrical current from the wire to the second electrical contacts;
an electrical connector disposed within the body and electrically connected to the wire, the electrical connector being configured to be connected to an external cable to receive the electric current from a power source; and
a light indicator disposed on the body, the light indicator being electrically connected in parallel to the second electrical contacts and configured to emit:
a first color light when the battery is charging; and
a second color light when the battery finished charging.
